(19) United States
(12) Patent Application Publication
(10) Pub. No.: US 2008/0252879 A1
(43) Pub. Date: Oct. 16, 2008

(54) OPTICAL SAMPLE MEASUREMENT DEVICE, OPTICAL CELL AND WATER QUALITY MEASUREMENT DEVICE

(76) Inventors: Masayoshi Ito, Kyoto (JP); Michio Murata, Kyoto (JP)

Correspondence Address: SNELL & WILMER LLP (OC), 600 ANTON BOULEVARD, SUITE 1400, COSTA MESA, CA, 92626, US

(21) Appl. No.: 12/099,340

(22) Filed: Apr. 8, 2008

(30) Foreign Application Priority Data
Apr. 13, 2007 (JP) P2007-105595

(51) Int. Cl. G01N 21/00; G01N 21/01

(52) U.S. Cl. 356/73; 356/432; 356/244; 356/440

(57) ABSTRACT

An optical sample measuring device such as a turbidity measurement instrument to isolate a portion of a fluid sample and isolate it from the influences of outside light. A sample cell in the instrument can include a cleaning unit that can contact transparent sections of the sample cell for an initial cleaning prior to a measurement cycle. A body member can further encompass a light source and one or more detectors for measuring the influence of the sample on light that is transmitted through and scattered by the fluid sample. The sample cell can be in a probe that can be immersed in the fluid and it can be operatively connected, for example, through a waterproof cable to a handheld measuring instrument body that can provide appropriate output of the measurement after processing the measurement signals.

### BACKGROUND OF THE INVENTION

1. Field of the Invention

The present claimed invention relates to an optical sample measurement device that measures particles in a sample, an optical cell used for the optical sample measurement device and a water quality measurement device that measures the turbidity in a liquid sample.

2. Description of Related Art

Conventionally, a turbidity measurement device that measures the turbidity in water by means of a transmitted light-scattered light method has been known. This kind of the turbidity measurement device comprises a light source that irradiates white light, a transparent measurement cell inside of which liquid to be measured flows, a transmitted light detecting device that detects the light that is irradiated from the light source and that passes through the measurement cell, and a scattered light detecting device that detects the light scattered by a turbidity component (particles) in the liquid to be measured, wherein the turbidity can be obtained by a ratio of an amount of the scattered light detected by the scattered light detecting device to an amount of the transmitted light detected by the transmitted light detecting device as known in Japanese Laid-Open Application 2000-206030.

In cases where a continued measurement is required by this turbidity measurement device, impure substances (for example, bacteria or adherent microalgae) in the liquid to be measured may attach to the measurement cell so that the optical transparency of the measurement cell is disturbed. As a result, the device becomes unable to conduct a measurement with high accuracy over a period of time. In order to solve this problem, a cleaning member driven by a motor for rubbing and cleaning a transmitted light window of the measurement cell is arranged so that the transmitted light window can be cleaned on a regular basis as shown in Japanese Laid-Open Applications 4-106747 and 9-113,440.

In Japanese Laid-Open Application 2000-206030, since the sample continues to flow during the cycle measurement, fluctuations can be generated at a time when the light passes through the sample. As a result, any light detected by the light detecting device contains an influence characteristic of the flow. In addition, since light (outside light) other than the light irradiated from the light source also may reach the light detecting device, the measurement result is influenced by the outside light.

With the arrangement described in the Japanese Laid-Open Applications 4-106747 and 9-113,440, since the cleaning member is driven by a motor, their structure becomes complicated. In addition, in case of using the turbidity measurement device immersed under water, the motor has to be protected from the water. Then there is a problem that the structure becomes further more complicated.

The above-mentioned problem applies to the turbidity measurement device that adopts not only the transmitted light-scattered light method but also other method wherein the turbidity is detected optically.

In addition, the influence by the flow of the sample or by the outside light is a problem that might be generated during measurement not only at a time when the turbidity of liquid is measured but also at a time when minute particles contained in gas is measured.

Thus, the field of liquid measurements by optical devices is still seeking improvements in performance.

### SUMMARY OF THE INVENTION

The present claimed invention focuses attention on the above-mentioned problems, and its main object is to provide an optical sample measurement device wherein a measurement result can be obtained with high accuracy without being influenced by a flow of the sample or by outside light and with securing an improved optical transparency by cleaning a portion where the light to be measured passes at a time of measuring minute particles with a simple structure.

More specifically, the optical sample measurement device in accordance with this invention comprises a body unit including a bulkhead having a transparent section that is at least partially transparent and a peripheral wall having a light blocking effect and arranged outside of the bulkhead so as to form a space between the bulkhead and the peripheral wall, wherein an opening section to take in a sample is arranged on the bulkhead and a sample introducing section is formed so that the sample can be confined inside the bulkhead. A cleaning unit comprising a cover section that has a light blocking effect and that is arranged to be movable relative to the body unit so as to be positioned at an opened position wherein the sample can be taken in and out from the sample introducing section by opening the opening section or at a closed position wherein the sample is confined in the sample introducing section by closing the opening section with making the relative movement and a cleaning section that makes a contact with an inner surface of the transparent section and that wipes and cleans the inner surface of the transparent section by making use of the relative movement.

A light source is arranged at a position to front the transparent section in the space and irradiates light on the sample at a time when the cover section is located at the above-mentioned closed position, and a light detecting section that is arranged at a position to front the transparent section in the space and that detects the light that is irradiated from the light source and that passes through the transparent section and the sample.

In accordance with this arrangement, it is possible to locate the cover section at the closed position by moving the body unit relative to the cleaning unit so that the sample taken into the sample introducing section can be temporarily confined in the sample introducing section. As a result, it is possible to still the sample in the sample introducing section and prevent any influence by the flow of the sample outside of the sample introducing section (for example, generation of the flow itself confined in the sample introducing section due to a flow of the sample outside of the sample introducing section). In addition, since both the peripheral wall and the cover section have the light blocking effect, it is possible to prevent outside light from reaching the light detecting section during the measurement.

As a result, it is possible for the light detecting section to detect only the light irradiated from the light source when it passes through the captured fluid sample. As mentioned, since only the light irradiated from the light source can be detected by the light detecting section, it is possible to conduct the measurement with high accuracy.

In addition, since the cleaning section wipes and cleans the inner surface of the transparent sample introducing section that fronts the light source and the light detecting section while the cleaning unit makes a movement relative to the body unit, it is possible to secure an improved optical transparency by cleaning the inner surface of the transparent sample introducing section every time the cleaning unit makes such a relative movement, resulting in a further accurate measurement.

As mentioned, it is possible to conduct the measurement with high accuracy with a simple structure wherein the cleaning and the operation of opening or closing the cover section can be conducted at once by making use of a positional relationship between the body unit and the cleaning unit. In addition, since the cleaning and the operation of opening or closing the cover section can be conducted simultaneously with a simple structure, this device can be preferably used also at a time when the measurement is conducted with this device immersed under water.

In order to make it possible to conduct a cleaning operation by the cleaning section with a simple structure, it is preferable that the cleaning unit comprises a substantially cylindrical tubular section, and the tubular section is so arranged to make a rotational movement as being the relative movement around a predetermined axis of the body unit that coincides with the center axis of the tubular section and the cleaning section is arranged on a side peripheral surface of the tubular section.

The cleaning section may be rotated through a sealed motor and gear assembly that could further be controlled by a controller or a microprocessor based system that can also process the measurement signals to provide a displayed output. Thus, the probe or sensory head of the measurement device can have a small motor to appropriately drive a relative movement between the sample cell and the cleaning unit to not only isolate a portion of the fluid for measurement purposes but also to block outside light and provide a preliminary cleaning mode of operation prior to a measurement mode of operation.

If the cover section is arranged at a part of an opening end section of the tubular section and is in a shape of a flat plate, a direction to which the cover section moves is within an opening surface of the opening end section. As a result, it is possible to make a resistance received from the sample at a time of opening or closing the cover section smaller than a case wherein a moving direction of the cover section is an axial direction of the opening surface, resulting in a simple rotational structure.

In order to make it possible to conduct the measurement by the use of the transmitted light-scattered light method, it is preferable that the light detecting section comprises a transmitted light detecting section that detects the transmitted light passing through the sample and a scattered light detecting section that detects the scattered light scattered on the sample.

An optical cell comprises a body unit comprising a bulkhead having at least partially a transparent section and a peripheral wall having a light blocking effect and arranged outside of the bulkhead so as to form a space between the bulkhead and the peripheral wall, wherein an opening section, to take in a sample, is arranged on the bulkhead and a sample introducing section is formed so that the sample can be confined inside the bulkhead, and a cleaning unit comprising a cover section that has a light blocking effect and that is arranged to be movably driven relative to the body unit so as to be positioned at an opened position wherein the sample can be taken in and out from the sample introducing section by opening the opening section or at a closed position wherein the sample is confined in the sample introducing section by closing the opening section with making the relative movement.

A cleaning section makes a contact with an inner surface of the transparent section and wipes and cleans the inner surface of the transparent section by making use of the relative movement, wherein it is possible to preferably apply this optical cell to, for example, the above-mentioned optical sample measurement device.

As a preferable embodiment of the water quality measurement device comprises a body unit comprising a bulkhead having at least a partially transparent section and a peripheral wall having a light blocking effect and arranged outside of the bulkhead so as to form an air tight section between the bulkhead and the peripheral wall, wherein an opening section to take in a sample is arranged on the bulkhead and a sample introducing section is formed so that the sample can be confined inside the bulkhead.

A cleaning unit comprising a cover section that has a light blocking effect and that is arranged to be movably driven relative to the body unit so as to be positioned at an opened position wherein the sample can be taken in and out from the sample introducing section by opening the opening section or at a closed position wherein the sample is confined in the sample introducing section by closing the opening section by the relative movement and a cleaning section that makes a contact with an inner surface of the transparent section and that wipes and cleans the inner surface of the transparent section by making use of the relative movement.

A light source is arranged at a position to front the transparent section in the air tight section and irradiates the light on the contained sample at a time when the cover section locates at the above-mentioned closed position, and a light detecting section is arranged at a position to front the transparent section in the air tight section and that detects the light that is irradiated from the light source and that passes through the transparent section and the sample.

In accordance with this arrangement, since the liquid sample does not enter the air tight section, it is possible to immerse the water quality measurement device or probe in the liquid sample. In addition, it is possible to locate the cover section at the closed position by moving the body unit relative to the cleaning unit so that the sample taken into the sample introducing section can be temporarily confined in the sample introducing section. As a result, it is possible to still the sample in the sample introducing section thereby preventing any influence by the flow of the sample outside of the sample introducing section (for example, generation of the flow itself confined in the sample introducing section due to a flow of the sample outside of the sample introducing section). In addition, since both the peripheral wall and the cover section have an external light blocking effect, it is possible to prevent outside light from reaching the light detecting section during the measurement mode of operation.

As a result, it is possible for the light detecting section to detect only the light irradiated from the light source. As mentioned, since only the light irradiated from the light source can be detected by the light detecting section, it is possible to conduct the measurements with high accuracy.

In addition, since the cleaning section wipes and cleans the inner surface of the transparent sample introducing section that fronts the light source and the light detecting section when the cleaning unit makes a movement relative to the body unit, it is possible to secure an improved optical transparency by cleaning the inner surface of the transparent sample introducing section every time the cleaning unit makes the relative movement, resulting in a further accurate measurement and it is possible to be preferably used for measuring environmental water such as seawater, lake water, river water, clean water or sewage water.

As mentioned, with the optical sample measurement device using an optical cell of this invention, it is possible to prevent any influence by the flow of the sample stream outside of the body unit and the influence by the outside light at a time of measurement and to secure an improved optical transparency by making the transparent section fronting the light source and the light detecting section every time the body unit makes a movement relative to the cleaning unit with a simple structure wherein the cleaning and the operation of opening or closing the cover section can be conducted at once by making use of a positional relationship between the body unit and the cleaning unit. As a result, it is possible to conduct the measurement with high accuracy.

In addition, in accordance with the water quality measurement device, since liquid sample does not enter the air tight section, it is possible to prevent a problem that the light source or the like accommodated in the air tight section becomes out of order due to the liquid sample. As a result, it is possible to be preferably used for measuring environmental water such as seawater, lake water, river water, clean water or sewage water so as to measure the turbidity in the sample with high accuracy.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a perspective view showing a water quality analyzer into which a turbidity measurement device in accordance with one embodiment of the present claimed invention is incorporated;

FIG. 2 is a structure cross sectional view of a sensor section of the water quality analyzer in accordance with this embodiment;

FIG. 3 is a perspective view showing the turbidity measurement device in accordance with this embodiment;

FIG. 4 is a view showing a longitudinal cross sectional view of the turbidity measurement device in accordance with this embodiment (cover section: opened position);

FIG. 5 is a view showing a d1-d1 section in FIG. 4 (cover section: opened position);

FIG. 6 is a perspective view showing a cleaning unit in accordance with this embodiment;

FIG. 7 is a plane view showing the cleaning unit in accordance with this embodiment;

FIG. 8 is a side view showing the cleaning unit in accordance with this embodiment;

FIG. 9 is a view showing a longitudinal cross sectional view of the turbidity measurement device in accordance with this embodiment (cover section: closed position);

FIG. 10 is a view showing a d2-d2 section in FIG. 9 (cover section: closed position);

FIG. 11 is a plane view showing a turbidity measurement device in accordance with another embodiment of the present claimed invention;

FIG. 12 is a view showing a longitudinal cross sectional view of the turbidity measurement device in accordance with this embodiment (cover section: opened position); and

FIG. 13 is a view showing a longitudinal cross sectional view of the turbidity measurement device in accordance with this embodiment (cover section: closed position).

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

One embodiment of the present claimed invention will be explained with reference to the drawings.

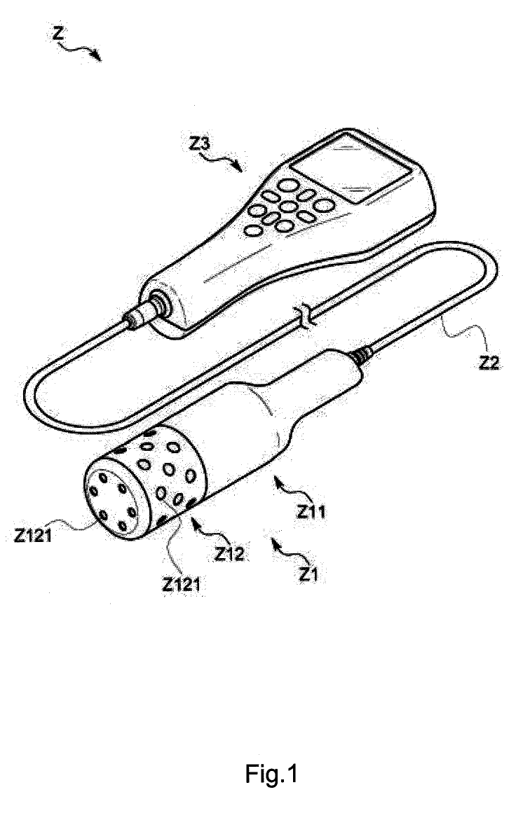

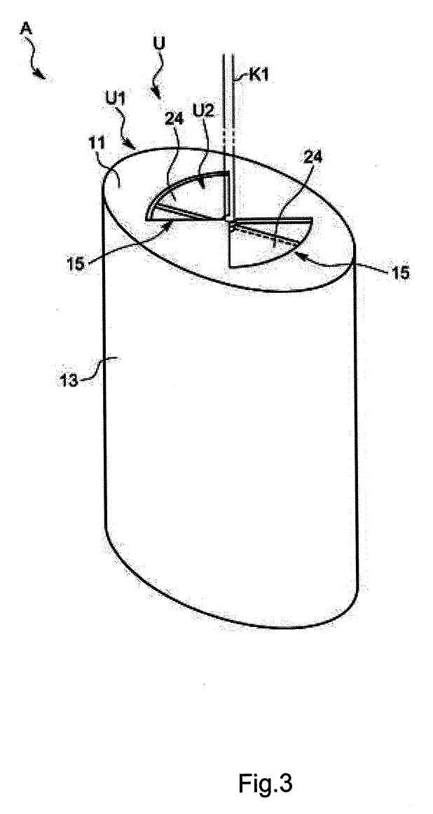

A turbidity measurement device A as a water quality measurement device in accordance with this embodiment comprises an optical cell U comprising a body unit U1 and a cleaning unit U2, and, as shown in FIG. 3, is incorporated into a water quality analyzer Z, as shown in FIG. 1, that can simultaneously conduct a continuous measurement of an item such as, for example, the pH, the conductivity, the dissolved oxygen concentration and the water temperature in addition to measuring the turbidity. The water quality analyzer Z comprises an immersion sensor section Z1 used in an immersed state under, for example, sea water or lake water and an instrument body Z3 that is electrically connected to the sensor section Z1 through a waterproof cable Z2.

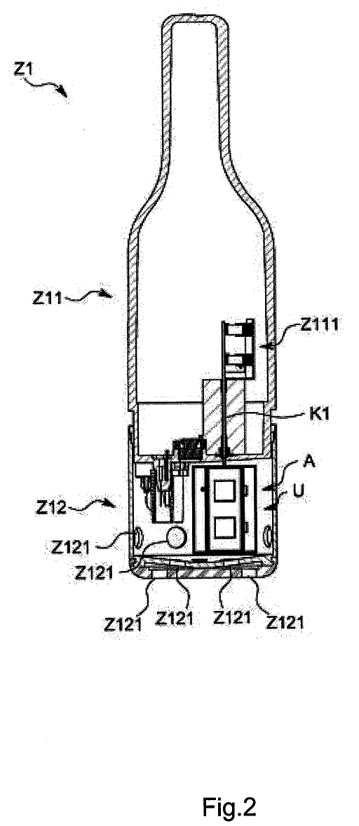

The sensor section Z1 comprises, as shown in FIG. 1 and FIG. 2, a water tight case Z11, and a sensor accommodating section Z12 that is arranged at a lower end section of the water tight case Z11 and that accommodates and protects various sensors and on which multiple through bores Z121 for taking in a sample are formed, and the turbidity measurement device A in accordance with this embodiment is accommodated in the sensor accommodating section Z12. (refer to FIG. 2)

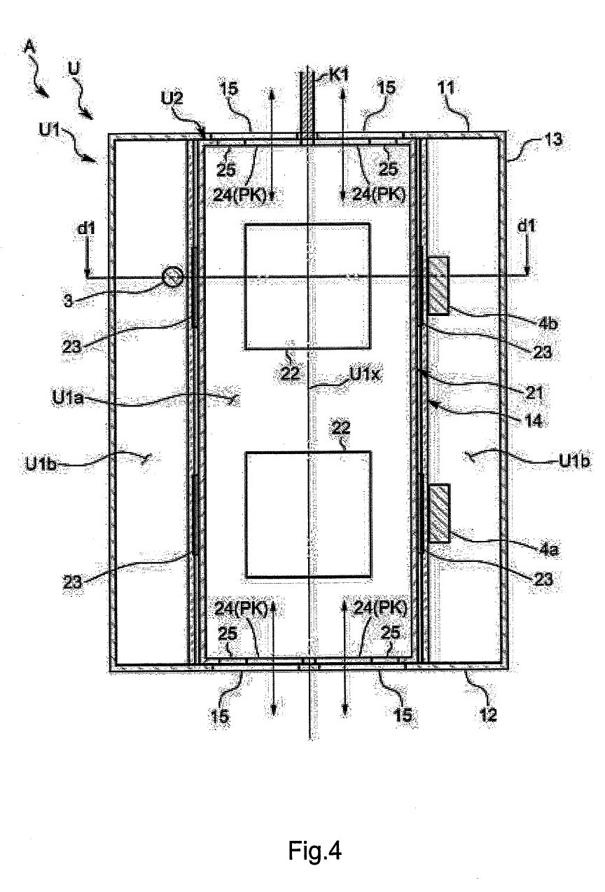

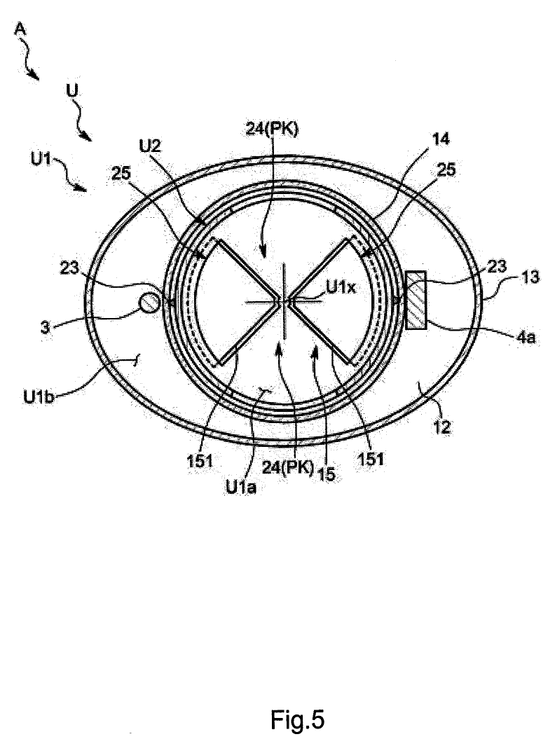

The turbidity measurement device A comprises, as shown in FIG. 3, FIG. 4 and FIG. 5, a body unit U1 of a substantially elliptical column shape in external view comprising a sample introducing section U1a that can confine a liquid sample (not shown in drawings) and an air tight section U1b into which no liquid sample enters. A cleaning unit U2 is arranged in the sample introducing section U1a, to make a rotational movement around a center axis U1x of the elliptical shape in the body unit U1 so that the sample can be introduced into the sample introducing section U1a or the sample can be confined in the sample introducing section U1a and that further cleans a predetermined section of the sample introducing U1a in association with the rotational movement.

A light source 3 is arranged in the air tight section U1b and irradiates the light on the liquid sample. A transmitted light detecting section 4a that detects the transmitted light passing through the liquid sample at a time when the light source 3 irradiates the light, and a scattered light detecting section 4b that detects the scattered light scattered by a turbidity component in the liquid sample is also provided.

In this embodiment, the cleaning unit U2 is so arranged to make a rotational movement relative to the body unit U1 by operating the instrument body Z3 as connected through the cable Z2. Each section will be explained as follows.

The body unit U1 comprises a top wall 11 and a bottom wall 12, each of which is of a substantially elliptical shape in a plane view and that have a light blocking effect, a side peripheral wall 13 that is arranged between the top wall 11 and the bottom wall 12 and that has a light blocking effect, a bulkhead 14 of a cylindrical shape (hereinafter called as a cylindrical bulkhead 14) whose both ends are connected to each inner surface of the top wall 11 and the bottom wall 12 and opening sections 15 arranged on both of the top wall 11 and the bottom wall 12. In this embodiment, the space U1a surrounded by the cylindrical bulkhead 14 is set as a sample introducing section that can temporarily confine the liquid sample taken through the opening section 15, and the space U1b surrounded by the cylindrical bulkhead 14, the top wall 11, the bottom wall 12 and the side peripheral wall 13 arranged outside of the cylindrical bulkhead 14 is set as a liquid-tight air tight section into which no liquid sample enters.

Each of the opening sections 15 are a bore of a substantial sector form whose central angle is 90 degrees in a plane view. Two opening sections 15 are arranged symmetrically with respect to a point by making use of a center of the sector form as a center point. In addition, in this embodiment, for example, whole of the cylindrical bulkhead 14 can be made of transparent glass (more specifically, whole of the cylindrical bulkhead 14 is “the transparent section” in this invention) and the top wall 11, the bottom wall 12 and the side peripheral wall 13 have not only the light blocking effect but also a resistance to water and the resistance to weather.

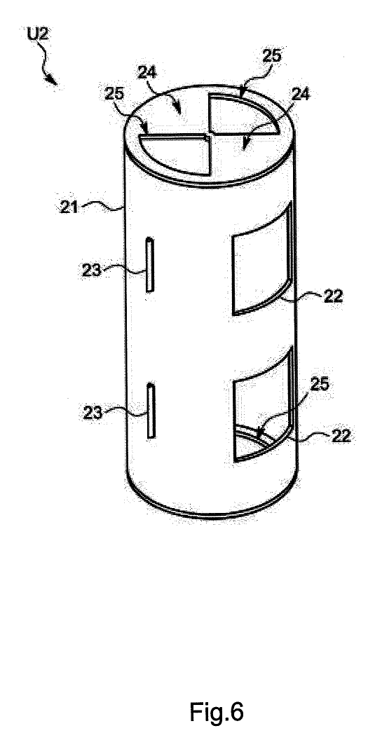

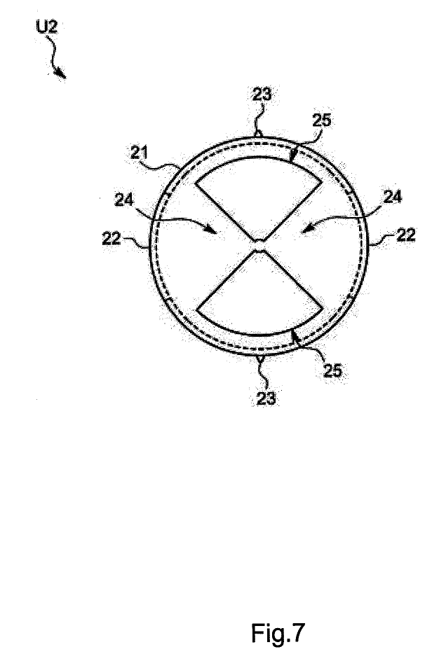

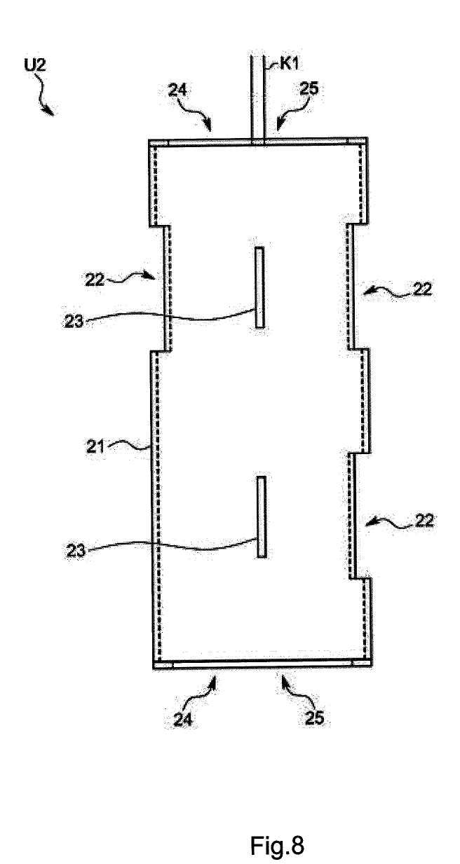

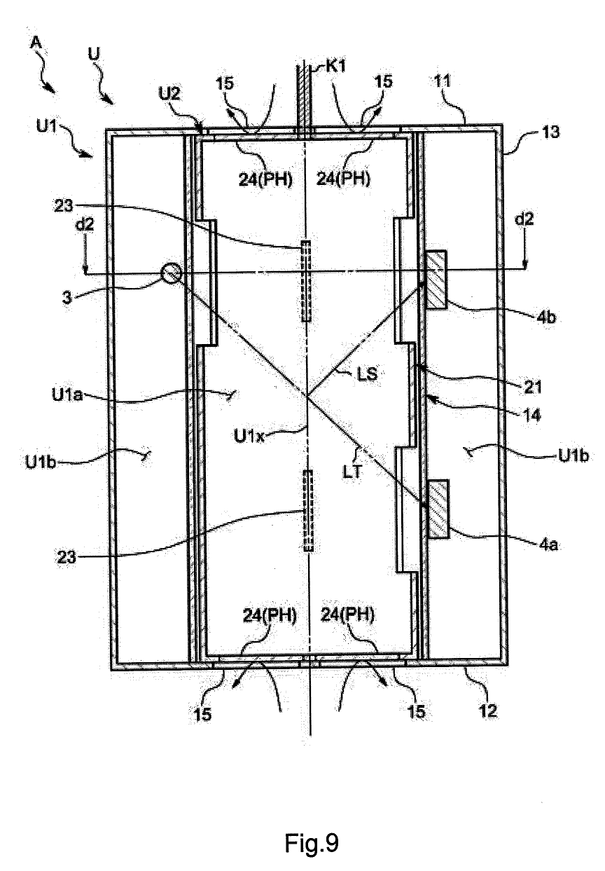

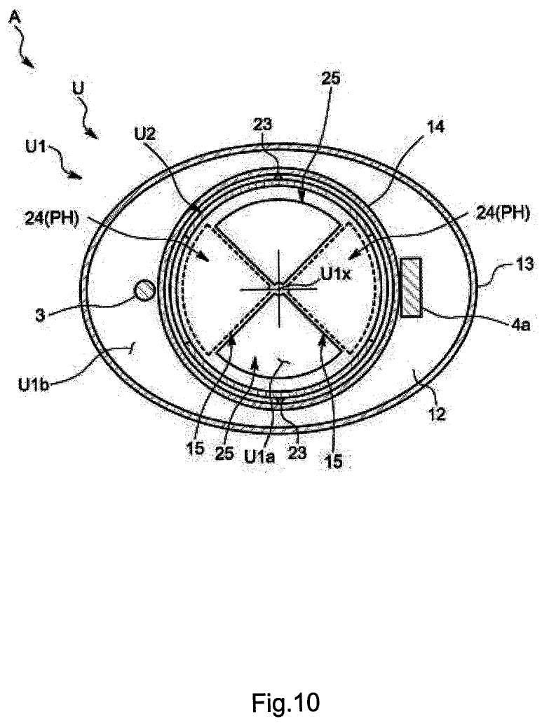

The cleaning unit U2 comprises, as shown in FIG. 6, FIG. 7, FIG. 8, FIG. 9 and FIG. 10, a substantially cylindrical tubular section 21, three light transmitting bores 22 formed on a side peripheral surface of the tubular section 21, a wiper 23 (corresponding to “the cleaning section” in this invention) that is arranged on the side peripheral surface of the tubular section 21 and at least a part of which makes a contact with an inner surface of the cylindrical bulkhead 14 so as to wipe and clean the inner surface of the cylindrical bulkhead 14 while the cleaning unit U2 makes a rotational movement.

A cover section 24 having a light blocking effect is arranged at a position where a part of the opening end section of both ends of the tubular section 21 is blocked, and a water introducing port 25 that is arranged on a part of the opening end section and configured so as not to be blocked by the cover section 24 and can introduce in or out the liquid sample into the tubular section 21.

The tubular section 21 has, for example, a resistance to water and also a resistance to weather in a similar manner as the top wall 11 of the body unit U1.

Each of the light transmitting bores 22 is a bore of a substantially rectangle shape and fronts the light source 3, the transmitted light detecting section 4a and the scattered light detecting section 4b respectively at a time when the cover section 24 locates at a closed position (PH).

Two wipers 23 are mounted at a height position where the light source 3 and the scattered light detecting section 4b is located and the other two wipers 23 are mounted on a height position where the transmitted light detecting section 4a is located, namely a total of four wipers 23 are mounted. In this embodiment, for example, since a longitudinal length of each wiper 23 is set to be longer than a longitudinal length of each light detecting section 4, it is possible to complete cleaning of each light detecting section 4 with one rotational movement.

In addition, in this embodiment, since the wiper 23 is made of an elastic material (for example, rubber), its transverse section is generally in a triangular shape and one side of the triangular shape is mounted on the tubular section 21, therefore, it is possible to clean the inner surface of the cylindrical bulkhead 14 by the use of the apex portion facing the side of the triangular shape of the wiper 23. With this arrangement, it is possible to obtain an improved cleaning effect without disturbing a smooth rotational movement of the cleaning unit U2.

The cover section 24 is of a substantial sector form whose central angle is 90 degrees. A half of an area of the opening end section of both ends of the tubular section 21 is blocked by arranging two cover sections 24 in symmetric with respect to a point by making use of a center of the sector form as a center point. Then a center of the cover section 24, located at a top surface side, is connected to one end of a rotational supporting axis K1. The other end of the rotational supporting axis K1 is axially supported by a turn supporting section Z11 in the water tight case Z11.

The cleaning unit U2 is rotated relative to the body unit U1 so that the cover section 24 locates at a predetermined position by rotating the rotational supporting axis K1 around its axis with a predetermined operation of the instrument body Z3. More specifically, it is possible for the cover section 24 to be located at an opened position (PK) wherein the liquid sample can go into and come out of the sample introducing section U1a by opening the opening section 15 or at a closed position (PH) wherein the liquid sample is confined inside the sample introducing section U1a by closing the opening section 15. In this embodiment, the cover section 24 has not only a light blocking effect but also resistant to water and resistant to weather, like the top wall 11 of the body unit U1.

The cleaning unit U2 may be rotated through a sealed motor and gear assembly driving along the support axis K1 that could further be controlled by a controller or a microprocessor based system that can also process the measurement signals to provide a displayed output. Thus, the probe or sensory head Z1 connected to the instrument body Z3 can employ a small motor to appropriately drive a relative movement between the sample cell and the cleaning unit U2 to not only isolate a portion of the fluid for measurement purposes in the bulkhead 14, but also to block outside light and provide a preliminary cleaning mode of operation prior to a measurement mode of operation.

Each of the water introducing ports 25 is a bore having a substantial sector form whose central angle is 90 degrees. A half of the area of the opening end section of both ends of the tubular section 21 is blocked by arranging two water introducing ports 25 in symmetric with respect to a point by making use of a center of the sector form as a center point.

The light source 3 uses, for example, a tungsten lamp. In this embodiment, the light is irradiated on the sample from the light source 3 at a time when the cover section 24 is located at the closed position (PH).

When the transmitted light detecting section 4a detects the transmitted light, the transmitted light detecting section 4a converts a luminous intensity of the transmitted light into an electrical signal and outputs it as a transmitted light detected signal to the instrument body Z3.

When the scattered light detecting section 4b detects the scattered light, the scattered light detecting section 4b converts a luminous intensity of the scattered light into an electrical signal and outputs it as a scattered light detected signal to the instrument body Z3.

In this embodiment, the light source 3 and the scattered light detecting section 4b are arranged generally at the same height and the transmitted light detecting section 4a is arranged at a height lower than that of the light source 3 and the scattered light detecting section 4b.

A method for measuring the turbidity in the water by the use of the turbidity measurement device A having the above structure will be explained.

(1) Taking in the sample;

first, a predetermined operation is provided with the instrument body Z3 to rotationally move the cleaning unit U2 relative to the body unit U1 so that the cover section 24 is located at the opened position (PK) while keeping the turbidity measurement device A immersed under the water. Since the opening section 15 opens with this operation, it is possible to take in the liquid sample into an inside of the sample introduction section U1a through the opening section 15 (refer to FIG. 4).

Next, a predetermined operation is provided with the instrument body Z3 to further rotationally (for example, more than a half through one rotation) move the cleaning unit U2 relative to the body unit U1 so that the cover section 24 will be located at the closed position (PH). Since the opening section 15 closes with this operation, it is possible to confine the liquid sample that has been taken inside of the sample introduction section U1a (refer to FIG. 9).

While the cleaning unit U2 makes a rotational movement relative to the body unit U1, the inner surface of the cylindrical bulkhead 14 is cleaned with a movement that the wiper 23 contacts the inner surface of the cylindrical bulkhead 14. As a result, an improved optical transparency can be secured for the cylindrical bulkhead 14, which makes it possible to conduct the measurement with high accuracy.

(2) At a time of measurement;

each light transmitting bore 22 of the cleaning unit U2 is positioned at a position fronting the light source 3, and the transmitted light detecting section 4a and the scattered light detecting section 4b are respectively positioned to receive light when the cover section 24 locates at the closed position (PH).

When the light is irradiated on the liquid sample from the light source 3 by providing the instrument body Z3 with a predetermined operation, the transmitted light LT passing through the liquid sample and the scattered light LS scattered by the turbidity component in the liquid sample are generated, as shown in FIG. 9.

When each of the transmitted light detecting section 4a and the scattered light detecting section 4b (hereinafter called as the light detecting section 4) detects the luminous intensity of the transmitted light LT and the luminous intensity of the scattered light LS respectively, the light detecting section 4 converts the luminous intensity into an electrical signal and outputs the electrical signal as the detected signal to the instrument body Z3.

Then the instrument body Z3 calculates an intensity ratio of the transmitted light LT and the scattered light LS based on each detected signal so that the instrument body Z3 can obtain a turbidity measurement by comparing the intensity ratio with the previously obtained intensity ratio.

Since the sample is confined in the sample introducing section U1a, it is possible to prevent any influence by the flow of the sample existing outside of the sample introducing section U1a (for example, to prevent generation of the flow in the sample itself confined in the sample introducing section U1a influenced by the flow of the sample existing outside of the sample introducing section U1a). As a result, it is possible to conduct the measurement with high accuracy.

In addition, since the top wall 11, the bottom wall 12 and the side peripheral wall 13 of the body unit U1 and the cover section 24 of the cleaning unit U2 have a light blocking effect, it is possible to prevent any outside light from entering the sample introducing section U1a and the air tight section U1b so that the outside light can be prevented from reaching the light detecting section 4. As a result, it is possible to conduct the measurement with high accuracy.

With the turbidity measurement device A of the above-mentioned arrangement in accordance with this embodiment, it is possible to conduct a measurement with high accuracy by preventing any influence from the flow of the sample outside of the body unit U1 and also any influence by the outside light at a time of measurement with a simple structure wherein the cover section 24 opens or closes the opening section 15 by making use of the positional relationship between the body unit U1 and the cleaning unit U2 makes a rotational movement around the central axis U1x of the body unit U1. Furthermore, since the wiper 23 wipes and cleans the inner surface of the cylindrical bulkhead 14 an improved optical transparency can be secured every time the cleaning unit U2 makes a rotational movement. As a result, it is possible to conduct the measurement with high accuracy.

More specifically, it is possible to provide a turbidity measurement device A that can measure the turbidity with high accuracy without receiving any characteristic influence by the flow of the sample or any influence by outside light at a time of measurement and securing an improved optical transparency by making a portion where the measurement light passes clean with a simple structure.

The cleaning and the operation of opening or closing the cover section 24 can be conducted at one time by making use of the positional relationship between the body unit U1 and the cleaning unit U2.

Since the opening section 15 is arranged on the top wall 11 and the bottom wall 12 of the body unit U1 respectively, it is possible to introduce the sample into the sample introducing section U1a easily. In addition, since a rotational direction of the cover section 24 is in a direction of a surface of the cover section 24, a resistance received from the sample at a time of opening or closing the cover section 24 becomes smaller compared with a case wherein a moving direction to open or close the cover section 24 is at an axial direction of the cover section 24. As a result, it is possible to realize a simple structure.

In addition, since no liquid sample enters the internal space of the air tight section U1b, a problem such as malfunction of the light source 3 because the liquid sample enters will not be generated. As a result, it is possible to measure the turbidity in the sample with high accuracy by preferably using the turbidity measurement device A for measuring environmental water such as sea water, lake water, river water, clean water or sewage water.

The present claimed invention is not limited to the above-mentioned embodiment.

For example, a structure of the optical cell U may be appropriately modified such that the cleaning unit U2 is slid to move toward a direction of a center axis U1x of the body unit U1.

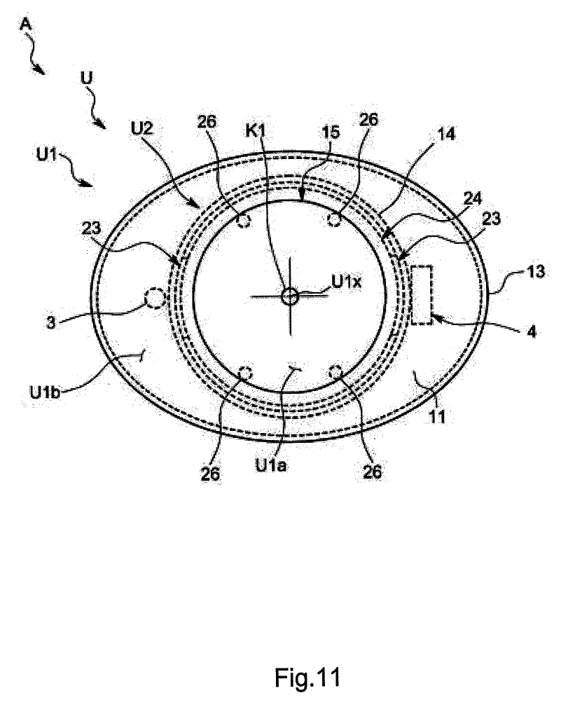

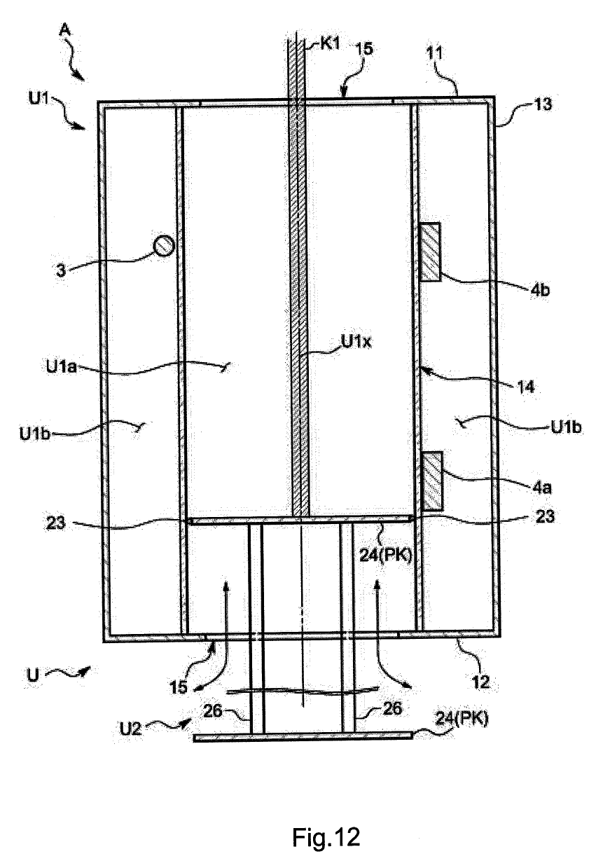

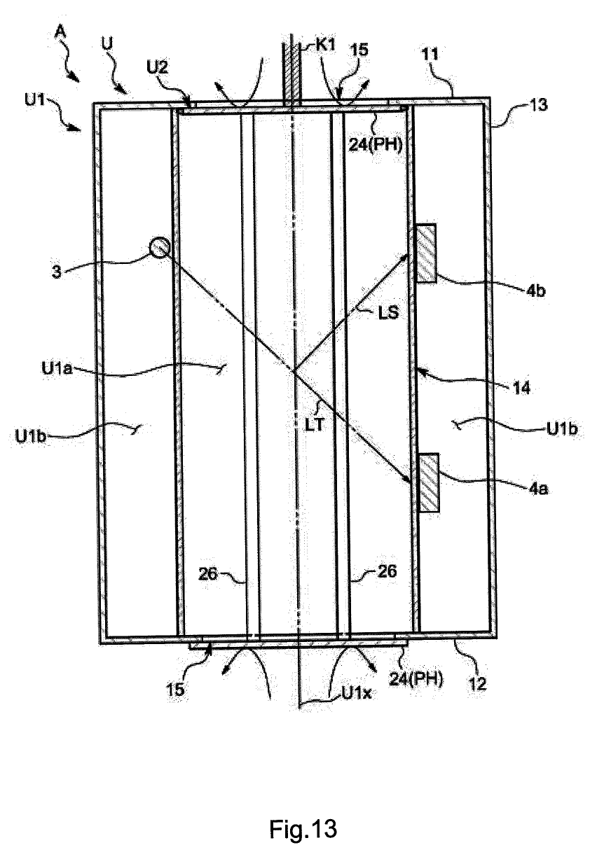

Specifically, as shown in FIG. 11, FIG. 12 and FIG. 13, the body unit U1 comprises opening sections 15 of a circular form in plane view formed on a top wall 11, a bottom wall 12, and the cleaning unit U2 comprises cover sections 24 each of which is a circular form having a diameter which is a little bigger than a diameter of the opening section 15 in a plane view. Four supporting posts 26 can connect the cover section 24 and the other cover section 24 and a wiper 23 can be mounted on a peripheral edge section of one of the cover sections 24 so that the cover sections 24 can be positioned at an opened position (PK) or a closed position (PH) by making a sliding movement of the cleaning unit U2 relative to the body unit U1.

In addition, the transmitted light-scattered light measuring method can be used as a measuring method in this embodiment, however, an alternative measuring method by making use of other light (a transmitted light measuring method, a surface scattered light measuring method, a scattered light measuring method, an integrating sphere method or the like) may be used. It is a matter of course that a kind, a number or an arranged place of the light source or the light detecting section can be appropriately modified in association with a specific measuring method to be adopted.

In addition, the light transmitting bore 22 of the cleaning unit U2 may be, for example, of a window made of glass.

A shape, a number, a material and an arranged place of the wiper 23 may be appropriately modified in association with the embodiment.

In addition, the object to be measured is not limited to the liquid sample and may be a gaseous sample. In case that the object is a gaseous sample, it is possible to measure a degree of minute articles contained in the gaseous sample. In this case, the air tight section U1b may be an ordinal space, not liquid tight.

Finally, the light source 3 may irradiate the light continuously. In this case, the detected signal may be taken by the scattered light detecting section 4b only at a time when the cover section 24 is located at the closed position (PH).

Each of the concrete structure is not limited to the above-mentioned embodiment, and may be variously modified without departing from a spirit of the invention.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. An optical sample measurement device comprising:
a body unit including a bulkhead having at least a partially transparent section and a peripheral wall having a light blocking effect and arranged outside of the bulkhead so as to form a space between the bulkhead and the peripheral wall, wherein an opening section to take in a sample is arranged on the bulkhead and a sample introducing section is formed so that the sample can be confined inside the bulkhead;
a cleaning unit comprising a cover section that has a light blocking effect and that is arranged to be movable relative to the body unit so as to be positioned at an opened position wherein the sample can be taken in and out from the sample introducing section by opening the opening section or at a closed position wherein the sample is confined in the sample introducing section by closing the opening section with making the relative movement and a cleaning section that makes a contact with an inner surface of the transparent section to wipe and clean the inner surface of the transparent section by making use of the relative movement;
a light source that is arranged at a position to front the transparent section in the space and that irradiates light on the sample at a time when the cover section locates at the above-mentioned closed position; and
a light detecting section that is arranged at a position to front the transparent section in the space and that detects the light that is irradiated from the light source and that passes through the transparent section and the sample.

2. The optical sample measurement device described in claim 1, wherein
the cleaning unit comprises a substantially cylindrical tubular section, and the tubular section is configured to provide a rotational movement as the relative movement around a predetermined axis of the body unit that coincides with the center axis of the tubular section and the cleaning section that is arranged on a side peripheral surface of the tubular section.

3. The optical sample measurement device described in claim 2, wherein
the cover section is arranged at a part of an opening end section of the tubular section and is in a shape of a flat plate.

4. The optical sample measurement device described in claim 1, wherein
the light detecting section comprises a transmitted light detecting section that detects the transmitted light passing through the sample and a scattered light detecting section that detects the scattered light scattered on the sample.

5. The optical sample measurement device described in claim 2 wherein
the light detecting section comprises a transmitted light detecting section that detects the transmitted light passing through the sample and a scattered light detecting section that detects the scattered light scattered on the sample.

6. The optical sample measurement device described in claim 3 wherein
the light detecting section comprises a transmitted light detecting section that detects the transmitted light passing through the sample and a scattered light detecting section that detects the scattered light scattered on the sample.

7. An optical cell comprising:
a body unit comprising a bulkhead having at least a partially transparent section and a peripheral wall having a light blocking effect and arranged outside of the bulkhead so as to form a space between the bulkhead and the peripheral wall, wherein an opening section to take in a sample is arranged on the bulkhead and a sample introducing section is formed so that the sample can be confined inside the bulkhead; and
a cleaning unit comprising a cover section that has a light blocking effect and that is arranged to be movable relative to the body unit so as to be positioned at an opened position wherein the sample can be taken in and out from the sample introducing section by opening the opening section or at a closed position wherein the sample is confined in the sample introducing section by closing the opening section with making the relative movement and a cleaning section that makes a contact with an inner surface of the transparent section and that wipes and cleans the inner surface of the transparent section by making use of the relative movement.

8. The optical cell of claim 7 wherein the peripheral wall has an elliptical configuration.

9. The optical cell of claim 8 wherein a light source is mounted between the peripheral wall and the bulkhead.

10. The optical cell of claim 9 wherein a light detecting section is mounted between the peripheral wall and the bulkhead.

11. The optical cell of claim 10 wherein the light source and the light detecting section are mounted on an axis of the elliptical configuration.

12. The optical cell of claim 7 wherein the bulkhead and the cleaning unit have cylindrical forms that are co-axial.

13. A water quality measurement device comprising:
a body unit comprising a bulkhead having at least a partially transparent section and a peripheral wall having a light blocking effect and arranged outside of the bulkhead so as to form an air tight section between the bulkhead and the peripheral wall, wherein an opening section to take in a sample is arranged on the bulkhead and a sample introducing section is formed so that the sample can be confined inside the bulkhead;
a cleaning unit comprising a cover section that has a light blocking effect and that is arranged to be movable relative to the body unit so as to be positioned at an opened position wherein the sample can be taken in and out from the sample introducing section by opening the opening section or at a closed position wherein the sample is confined in the sample introducing section by closing the opening section with making the relative movement and a cleaning section that makes a contact with an inner surface of the transparent section and that wipes and cleans the inner surface of the transparent section by making use of the relative movement; and
a light source that is arranged at a position to front the transparent section in the air tight section and that irradiates the light on the sample at a time when the cover section locates at the above-mentioned closed position, and
a light detecting section that is arranged at a position to front the transparent section in the air tight section and that detects the light that is irradiated from the light source and that passes through the transparent section and the sample.

14. An improved optical sample measuring device that can be immersed within a fluid sample source comprising:
a handheld measuring instrument body for providing an output of a measurement of the fluid sample source; and
a probe configured for immersion in the fluid sample and operatively connected to the handheld measuring instrument body, the probe including a sample introducing section for receiving and isolating a portion of the fluid sample source, a sample cell for holding the isolated sample portion within the probe including portions for transmission of light into and out of the sample cell and means for cleaning the transmission portion and blocking exterior light from entering the sample cell during a measurement mode of operation.

15. The optical sample measuring device of claim 14 wherein the means for cleanout out blocking includes a cylindrical hollow member with openings in at least one end for admitting fluid to be isolated at an open position and cleaning elements on the cylindrical wall to clean the transmission portions of the sample cell when rotated.
